(19) United States
(12) Patent Application Publication
(10) Pub. No.: US 2008/0078062 A1
(43) Pub. Date: Apr. 3, 2008

(54) SWIVEL HINGE FOR PORTABLE ELECTRONIC DEVICE

(75) Inventors: SHENG-CHENG HSU, Tu-Cheng (TW); PU LUO, Shenzhen (CN); FAN-MING MENG, Shenzhen (CN); JIN-BU CAI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/623,296

(22) Filed: Jan. 15, 2007

(30) Foreign Application Priority Data
Sep. 5, 2006 (CN) 200610200843.1

(51) Int. Cl. E05D 3/10

(52) U.S. Cl. 16/367

(57) ABSTRACT

An exemplary swivel hinge assembly (10) includes a main body (10), a pivot mechanism (16) and a swivel mechanism. The pivot mechanism is connected to the main body and configured to provide the swivel hinge assembly with rotation about a first rotational axis. The swivel mechanism is configured to provide the swivel hinge assembly with rotation about a second rotational axis. The swivel mechanism includes a pivot shaft (189), a friction piece (184) and a pair of elastic pieces (188). The second pivot shaft is rotatably extended through the main body. The friction piece is non-rotatably mounted on the pivot shaft. The elastic pieces are mounted on the main body and elastically resist the friction piece.

### BACKGROUND OF THE INVENTION

1. Field of the Invention

The present invention relates generally to swivel hinges, and more particularly to a swivel hinge used in folding portable electronic devices.

2. Discussion of the Related Art

Generally, portable wireless terminals allow users to communicate with users of another terminal wirelessly. Such portable wireless terminals are classified into bar-type, flip-type, and folder-type terminals according to the external appearance. The bar-type terminal includes a single housing having a bar-shape. The flip-type terminal includes a flip or a display holder rotatably coupled to a bar-type housing by means of a hinge device. The folder-type terminal includes a folder rotatably and foldably coupled to a single bar-type housing by means of a hinge device.

The above-mentioned portable wireless terminals are well known to those skilled in the art, and typically include an antenna device, a data input/output device, and a data transmitting/receiving device. Generally, a keypad allowing a user to input data by pushing the keypad with his/her fingers is mainly used as a data input device. A touch pad or a touch screen also can be used as a data input/output device. In addition, an LCD (Liquid Crystal Display) is mainly used as a data output device, i.e. a display.

Recently, users' demands for portable wireless terminals have become diversified. However, although various kinds of additional devices, such as cameras or camcorders, have been added to portable wireless terminals, the display for data output is usually rotated around only one axis in such a portable wireless terminal. That is, the display is usually only tiltable about a horizontal pivot. When photographing an object or video communicating with a user at another terminal, the portable wireless terminal is usually positioned so that the display thereof is oriented vertically and that the user can look directly at the display. Therefore the portable wireless terminal which can only tilt about the horizontal pivot can be quite inconvenient in use.

Therefore, a portable wireless terminal having a display that is rotatable about more than one axis is desired. More particularly, a hinge assembly which can connect such a display to a main body of a portable wireless terminal is desired.

### SUMMARY

An exemplary swivel hinge assembly includes a main body, a pivot mechanism and a swivel mechanism. The pivot mechanism is connected to the main body and configured to provide the swivel hinge assembly with rotation about a first rotational axis. The swivel mechanism is connected to the main body and configured to provide the swivel hinge assembly with rotation about a second rotational axis. The swivel mechanism includes a pivot shaft, a friction piece, and a pair of elastic pieces. The pivot shaft is extended through the main body and is rotatable relative to the main body about the second rotational axis. The friction piece is non-rotatably mounted around the pivot shaft. The elastic pieces are mounted on the main body and elastically resist the friction piece.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the swivel hinge assembly and an associated electronic device. Moreover, in the drawings, like reference numerals designate corresponding parts throughout the several views.

FIG. 1 is an exploded, isometric, inverted view of a swivel hinge assembly in accordance with a preferred embodiment of the present invention.

FIG. 2 is an assembled view of the swivel hinge assembly shown in FIG. 1.

FIG. 3 is a cross-sectional view of the swivel hinge assembly shown in FIG. 2, taken along line 111-111 thereof.

FIG. 4 is an isometric view of a mobile phone with the swivel hinge assembly of FIG. 2, showing a display holder of the mobile phone rotatable about a first rotational axis and a second rotational axis.

### DETAILED DESCRIPTION OF THE EMBODIMENTS

The present application provides a swivel hinge assembly used in foldable electronic devices that include two components rotably attached to each other such as mobile phones, personal digital assistants (PDAs), and digital videos (DVs). Hereinafter, for convenience and brevity, the swivel hinge assembly as used in a mobile phone is described and illustrated.

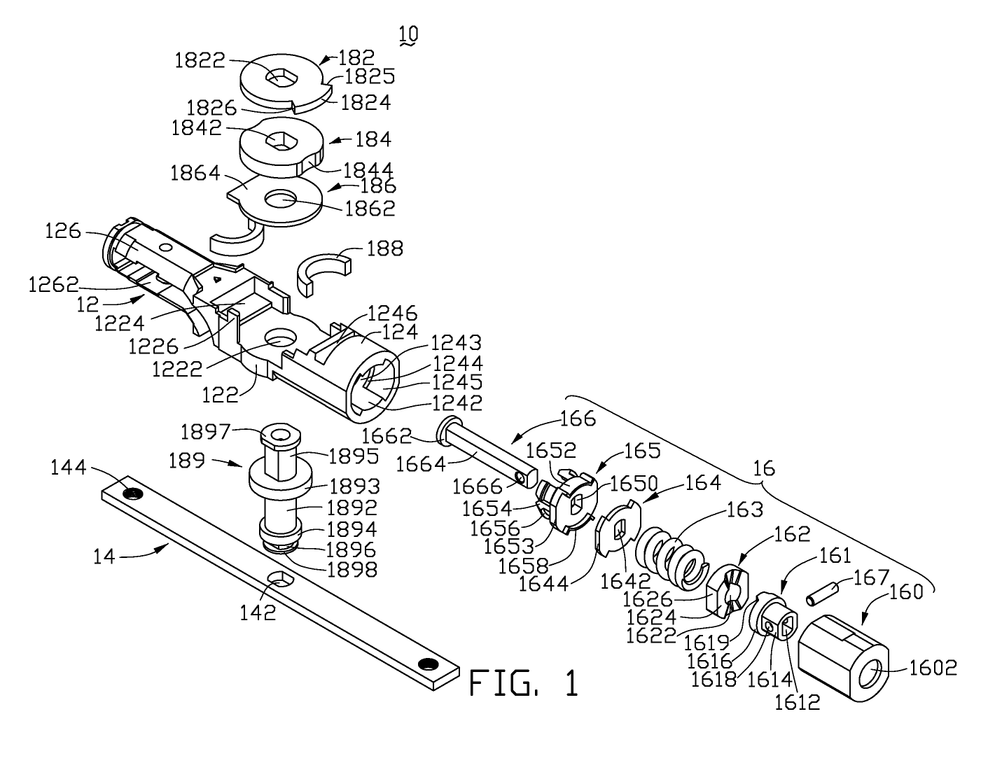

Referring to the drawings in detail, FIG. 1 shows a swivel hinge assembly 10 of one embodiment of the present invention. The swivel hinge assembly 10 includes a main body 12, a rotatable plate 14, a swivel mechanism (not labeled), and a pivot mechanism 16. The swivel hinge assembly 10 provides rotation about a first rotational axis by virtue of the pivot mechanism 16, and rotation about a second rotational axis perpendicular to the first axis by virtue of the swivel mechanism.

The main body 12 includes a swivel 122, with a first arm 126 and a second arm 124 extending from opposite ends of the swivel 122. The main body 12 is integrally formed. A swivel shaft hole 1222 is defined in a center of the swivel 122, with an axis of the swivel shaft hole 1222 aligned with the second rotational axis. The swivel 122 further defines two receiving grooves 1224. The receiving grooves 1224 are symmetrically defined adjacent two sides of the swivel shaft hole 1222. Each receiving groove 1224 is defined by three sidewalls, and has an open side facing the swivel shaft hole 1222. One sidewall adjacent to the open side for defining one of the receiving grooves 1224 forms a limiting protrusion 1226.

In a preferred embodiment, the first arm 126 defines a wiring channel 1262 that is used for wiring the two components of the mobile phone, and the second arm 124 defines a hinge shaft hole 1243 with an axis of rotation aligned with the first rotational axis. The hinge shaft hole 1243 has a hinge shaft hole wall 1242 having a radius equal to a radius of the hinge shaft hole 1243. The hinge shaft hole wall 1242 defines at least one inner slot 1245 thus forming a step 1244 in the hinge shaft hole 1243. In the preferred embodiment, the hinge shaft hole wall 1242 defines two inner slots 1245. Each inner slot 1245 is arc-shaped, with a radius greater than a radius of the hinge shaft hole 1243. The two inner slots 1245 are symmetrically opposite to each other on the curved hinge shaft hole wall 1242, and respectively communicate with the hinge shaft hole 1243. The second arm 124 further defines at least two hook slots 1246 on opposite sides of the second arm 124. The hook slots 1246 are through holes that communicate from the hinge shaft hole wall 1242 to an exterior surface of the second arm 124.

The rotatable plate 14 is an oblong sheet defines a first latch hole 142 and two mounting holes 144. As seen in FIG. 1, the first latch hole 142 has a shape of a circle with two flattened sides. The mounting holes 144 are used for attaching the rotatable plate 14 in the mobile phone, and in the preferred embodiment, the mounting holes 144 are threaded. For example, two bolts are provided to screw into the mounting holes 144 so as to fix the rotatable plate 14 to the mobile phone. The rotatable plate 14 may instead have another suitable shape. For example, the rotatable plate 14 may instead be a bar having a circular or square cross-section.

The pivot mechanism 16 includes a first pivot shaft 166, a grasping member 165, a tab washer 164, an elastic member 163, a cam follower 162, a cam 161, a pin 167, and a hinge cup 160.

The first pivot shaft 166 includes a cap 1662 and a shaft 1664. The cap 1662 is located at one end of the shaft 1664, and is larger than the shaft 1664. Another end of the shaft 1664 defines a first pinhole 1666. The first pinhole 1666 traverses the shaft 1664, i.e., the first pinhole 1666 has an axis perpendicular to an axis of the shaft 1664. The shaft 1664 is flattened, and has a cross-section having a shape of a circle with two flattened sides. Alternatively, the cross-section of the shaft portion 1664 of the first pivot shaft 166 may be other non-circular shape. For example, the cross-section can be triangular, pentagonal, or hexagonal.

The grasping member 165 defines a first keyed hole 1650 in a center. The first keyed hole 1650 has a shape of a circle with two flattened sides so as to form a cross-section approximately the same as the cross-section of the shaft 1664 of the first pivot shaft 166. The grasping member 165 includes a base 1652. The base 1652 forms two first projections 1653 at a periphery. The first projections 1653 are configured to be engaged in the inner slots 1245 of the main body 12. One end of the base 1652 forms at least two hooks 1654 extending perpendicularly from a periphery of the base 1652. In this embodiment, there are four hooks 1654. Each of the hooks 1654 has a latching surface 1656. Another end of the base 1652 forms two protruding rims 1658. Each of the protruding rims 1658 extends along an edge of the base 1652 in a direction parallel to an axis of the base 1652.

The tab washer 164 is a sheet defining a second keyed hole 1642, and forms a two second projections 1644 at a periphery thereof. The second keyed hole 1642 has a shape of a circle with two flattened sides so as to form a cross-section approximately the same as the cross-section of the shaft 1664 of the first pivot shaft 166. The second projections 1644 are configured to be engaged in the inner slots 1245 of the main body 12. The tab washer 164 is received between the protruding rims 1658 of the grasping member 165. The tab washer 164 is disposed between the elastic member 163 and the grasping member 165 for preventing friction therebetween. Instead, friction is generated between the elastic member 163 and the tab washer 164. Therefore, abrasion of the grasping member 165 is minimal.

In the preferred embodiment, a helical spring is adopted as the elastic member 163. The elastic member 163 is extendable and compressible. In other embodiments, a rubber bar another kind of elastic piece may also be adopted as the elastic member 163. The elastic member 163 is configured to provide an axial force.

The cam follower 162 has a cross-section having a shape of a circle with two flattened sides. The cam follower 162 defines a circular through hole 1622 in a center of the cam follower 162, and a cam surface 1624 at an end. The cam surface 1624 defines a pair of valleys (not labeled). The cam follower 162 has two symmetrical flat surfaces 1626.

A center of the cam 161 defines a third keyed hole 1612. The third keyed hole 1612 has a shape of a circle with two flattened sides so as to form a cross-section approximately the same as the cross-section of the shaft 1664 of the first pivot shaft 166. Alternatively, the cross-section of the shaft 1664 of the first pivot shaft 166 and the first, second, third keyed holes 1650, 1642, 1612 may have other non-circular shapes such as triangular, pentagonal, and hexagonal, so long as the first pivot shaft 166 is non-rotatably extended through the grasping member 165, the tab washer 164, and the cam 161. The cam 161 includes a neck portion 1614, and a cam portion 1616 with a diameter larger than that of the neck portion 1614. The neck portion 1614 defines a transverse second pinhole 1618 therethrough. That is, the second pinhole 1618 has an axis perpendicular to an axis of the cam 161. The cam portion 1616 defines a cam surface 1619, for engaging with the cam surface 1624 of the cam follower 162. The cam portion 1616 forms a pair of peaks (not labeled) for engaging in the valleys of the cam follower 162.

The pin 167 is a cylinder configured to be inserted into the second pinhole 1618 of the cam 161 and the first pinhole 1666 of the first pivot shaft 166. The pin 167 is used for retaining the grasping member 165, the tab washer 164, the elastic member 163, the cam follower 162, and the cam 161 on the first pivot shaft 166.

The hinge cup 160 defines an open end, a polygonal hinge cup cavity, and a hinge cup hole 1602 at a base of the hinge cup 160 communicating with the hinge cup cavity. The hinge cup cavity has at least one flattened section so as to non-rotatably receive the cam follower 162. In the preferred embodiment, the hinge cup cavity has two symmetrical flattened sections that face each other.

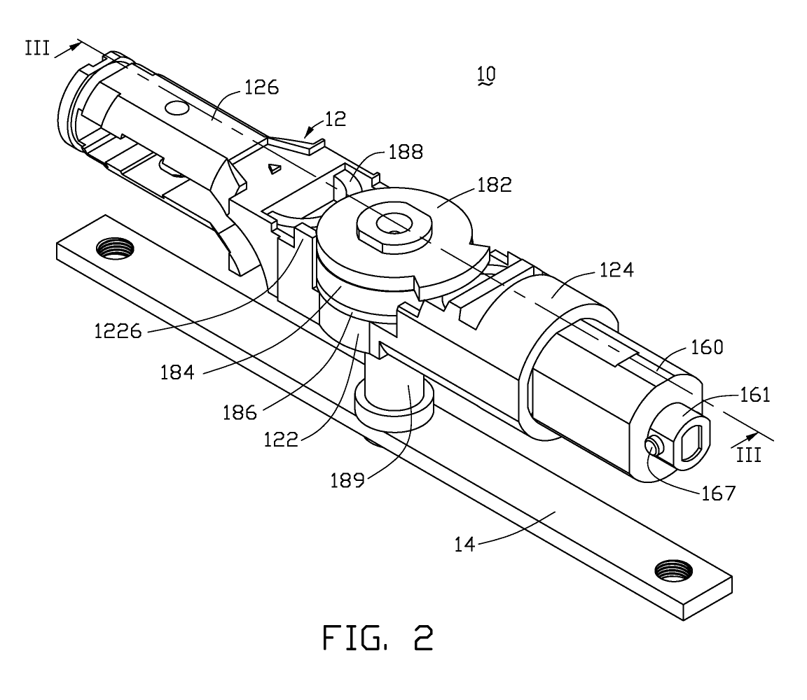

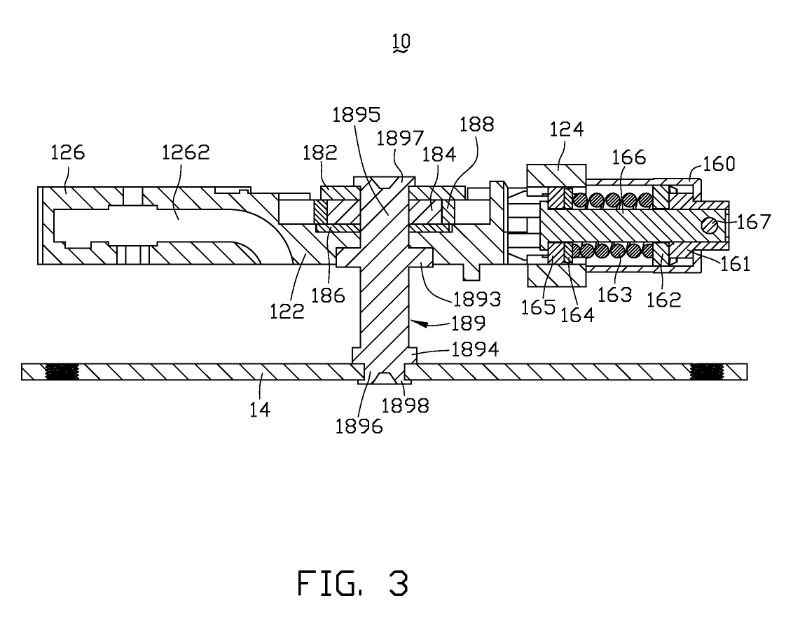

Referring to FIG. 2 and FIG. 3, to assemble the pivot mechanism 16, the shaft 1664 of the first pivot shaft 166 is extended through the first keyed hole 1650 of the grasping member 165, the second keyed hole 1642 of the tab washer 164, the elastic member 163, the through hole 1622 of the cam follower 162, the third keyed hole 1612 of the cam 161, and the hinge cup 160, in that order. The neck portion 1614 of the cam 161 and a part of the first pivot shaft 166 protrudes out of the hinge cup 160 from the hinge cup hole 1602. Then the second pinhole 1618 of the cam 161 and the first pinhole 1666 of the first pivot shaft 166 is inserted with the pin 167 so as to prevent the first pivot shaft 166, the grasping member 165, the tab washer 164, the elastic member 163, the cam follower 162, the cam 161 and the hinge cup 160 from disengaging from each other. The hooks 1654 of the grasping member 165 are pushed inwards so that the hooks 1654 are able to extend through the hinge shaft hole 1243 of the second arm 124, and protrude into the hook slots 1246 of the second arm 124 of the main body 12. Thus, the latching surfaces 1656 of the hooks 1654 of the grasping member 165 hooks an end wall defining the hook slots 1246, and the base 1652 of the grasping member 165 claws the step 1244 of the main body 12, such that the grasping member 165 is fixed to the main body 12, thus connecting the pivot mechanism 16 to the main body 12.

After the pivot mechanism 16 is assembled, the cam follower 162, a portion of the cam follower 161 and a portion of the elastic member 163 are received in the hinge cup cavity of the hinge cup 160, and the tab washer 164, the other portion of the elastic member 163 and a portion of the grasping member 165 are received in the hinge shaft hole 1243 of the second arm 124 of the main body 12. The cam surface 1619 of the cam 161 engages with the cam surface 1624 of the cam follower 162. The two peaks of the cam 161 resist the cam follower 162, with the elastic member 163 being compressed between the tab washer 164 and the cam follower 162. The cam 161 is rotatable relative to the cam follower 162. The cam follower 162 is non-rotatable relative to the hinge cup 160, and the cam 161, the tab washer 164, the grasping member 165 and the first pivot shaft 166 are non-rotatable relative to the main body 12.

In alternative embodiments, the first pinhole 1666 of the first pivot shaft 166, the second pinhole 1618 of the cam 161, the neck portion 1614 of the cam 161, and the pin 167 may be omitted. Instead, for example, the first pivot shaft 166 defines a screw thread and a nut is provided to engage with the screw thread. In another example, an end of the first pivot shaft 166 is riveted by a riveting machine.

The swivel mechanism includes a second pivot shaft 189, a limiting piece 182, a friction piece 184, a flat washer 186, and a pair of elastic pieces 188.

The second pivot shaft 189 includes a first shaft portion 1895, a first stopping portion 1893, a second shaft portion 1892, a second stopping portion 1894, and a third shaft portion 1896 arranged in that order. The third shaft portion 1896 has a cross-section approximately the same as a shape of the first latch hole 142 of the rotatable plate 14.

The limiting piece 182 is substantially a ring defining a second latch hole 1822 in a center thereof. The second latch hole 1822 has a shape of a circle with two flattened sides. The limiting piece 182 forms a block 1824 at a periphery thereof. The block 1824 has two limiting surfaces 1825, 1826. The block 1824 engages with the limiting protrusion 1226 of the main body 12 so as to restrict a rotational angle of the swivel hinge assembly 10 about the second rotational axis.

The friction piece 184 is substantially a ring defining a third latch hole 1842 in a center thereof. The third latch hole 1842 has a shape of a circle with two flattened sides. The friction piece 186 defines two symmetrical depressions 1844. The first shaft portion 1895 of the second pivot shaft 189 has a cross-section approximately the same as a shape of the second and third latch holes 1822, 1842 of the limiting piece 182 and the friction piece 184. Alternatively, the first, second, and third latch holes 142, 1822, and 1842, and the first, second, and third shaft portions 1895, 1892, and 1896 may also have other non-circular shapes such as triangular, pentagonal and hexagonal, so long as the second pivot shaft 189 is non-rotatable in the first, second and third latch holes 142,1822 and 1842.

The flat washer 186 defines a circular center hole 1862 and forms a rectangular portion 1864 at an edge thereof. The flat washer 186 is disposed between the friction piece 184 and the main body 12 for preventing direct friction between them. Instead, friction is generated between the friction piece 184 and the flat washer 186. Therefore, abrasion of the main body 12 is minimal.

Each of the elastic pieces 188 is generally arc-shaped. In this embodiment, the elastic piece 188 is a half ring. A side of each of the elastic pieces 188 is abuts the depression 1844 of the friction pieces 184 correspondingly. In alternative embodiments, only a single elastic piece 188 may be provided, or three, four or more elastic pieces 188 may be provided. Correspondingly, one, three, four or more depressions 1844 are defined in the friction piece 184.

Referring to FIG. 2 and FIG. 3 again, in assembly of the swivel mechanism, the flat washer 186 is disposed on the swivel 122 of the main body 12 with the hinge cup hole 1602 aligned with the swivel shaft hole 1222. Ends of the elastic pieces 188 are disposed in the receiving grooves 1224 of the swivel 122. Then the first shaft portion 1895 is extended through the swivel shaft hole 1222 of the main body 12, the center hole 1862 of the flat washer 186, the third latch hole 1842 of the friction piece 184, and the second latch hole 1822 of the limiting piece 182, in that order. The third shaft portion 1896 is extended through the first latch hole 142 of the rotatable plate 14. After that, an end of the first shaft portion 1895 and an end of the third shaft portion 1896 are riveted to form a first riveted portion 1897 and a second riveted portion 1898 respectively, thus preventing the rotatable plate 14, the main body 12, the flat washer 186, the friction piece 184, and the limiting piece 182 from disengaging from the second pivot shaft 189. The second pivot shaft 189 is rotatable relative to the main body 12. The rectangular portion 1864 of the flat washer 186 is restricted between three sidewalls that bound the corresponding receiving groove 1224 of the main body 12, such that the flat washer 186 is non-rotatable relative to the main body 12. The two elastic pieces 188 are disposed with the convex sides thereof facing each other. The limiting piece 182, the friction piece 184, the rotatable plate 14, and the second pivot shaft 189 are non-rotatable relative to the main body 12.

In alternative embodiments, the first and second riveted portions 1897,1898 may be omitted. Instead, for example, the second pivot shaft 189 defines two screw threads at two ends thereof, and two nuts are provided to engage with the screw threads. In another example, two pins may be provided, and two pinholes are defined in the second pivot shaft 189. The pins are engaged in the pinholes in a way similar to the way the pin 167 engages in the first pinhole 1666 of the pivot shaft 166 and the second pinhole 1618 of the cam 161.

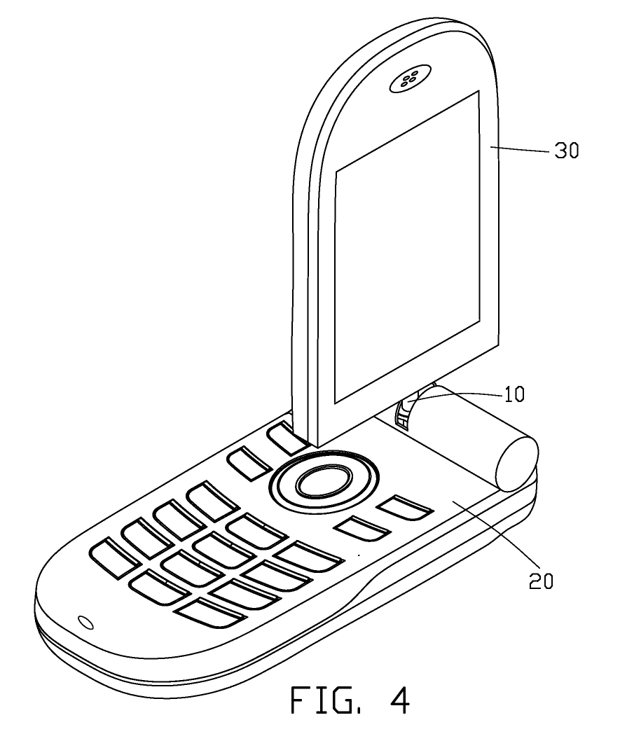

Referring to FIG. 4, the mobile phone includes a base body 20, a display holder 30, and the swivel hinge assembly 10 for rotatably connecting the base body 20 and the display holder 30. When the swivel hinge assembly 10 is employed in the mobile phone, the hinge cup 160 is non-rotatably connected to the base body 20, and the rotatable plate 14 is fixed to the display holder 30. In a state of the mobile phone as shown in FIG. 4, the display holder 30 has been rotated about the first rotational axis and rotated the second rotational axis through respective angles.

In use, when the display holder 30 is manually rotated about the first rotational axis, the cam 161, the tab washer 164, the grasping member 165, the first pivot shaft 166, the main body 12, the rotatable plate 14, and the swivel mechanism rotate together with the display holder 30 relative to the base body 20 and the hinge cup 160, with the cam follower 162 being fixed relative to the base body 20. In a normal starting position of the display holder 30 in relation to the first rotational axis, the peaks of the cam 161 are received in the valleys of the cam follower 162. The normal starting position is typically when the mobile phone is folded up and not in use. In such position, the display holder 30 is referred to herein as being in a closed state relative to the base body 20. When the display holder 30 rotates about the first rotational axis, the peaks slide out of the valleys, and drive the elastic member 163 to be compressed further. After rotating through a predetermined angle, the peaks of the cam 161 return into the valleys of the cam follower 162, and thus the elastic member 163 is at rest again. At this position, the display holder 30 stops rotating further, and the display holder 30 is in an open state relative to the base body 20. The cam 161 can be retained at any position relative to the cam follower 162 during the rotating of the display holder 30, because the cam surface 1624 of the cam follower 162 is approximately flat. Therefore, the display holder 30 can be rotated about the first rotational axis and retained in any desired position relative to the base body 20 between the closed state and the open state.

When the display holder 30 is manually rotated about the second rotational axis, the rotatable plate 14, the limiting piece 182, the friction piece 184, and the second pivot shaft 189 rotate together with the display holder 30 relative to the combination of the base body 20 and the main body 12, with the flat washer 186 and the pivotal mechanism 16 being fixed relative to the base body 20. In a normal starting position of the display holder 30 in relation to the second rotational axis, the convex sides of the elastic pieces 188 abut the depressions 1844 of the friction piece 184. When the display holder 30 rotates and reaches a predetermined angle in a first rotating direction, the limiting surface 1825 of the block 1824 of the limiting piece 182 resists the limiting protrusion 1226 of the main body 12 to prevent the display holder 30 from rotating further. When the display holder 30 rotates and reaches a predetermined angle in a second rotating direction opposite to the first rotating direction, the limiting surface 1826 of the block 1824 of the limiting piece 182 resists the limiting protrusion 1226 of the main body 12 to prevent the display holder 30 from rotating further. Thereby, a rotation angle of the display holder 30 relative to the base body 20 is restricted. When the display holder 30 rotates, the friction piece 184 rotates relative to the elastic pieces 188, such that the elastic pieces 188 move away from the depressions 1844 of the friction piece 184. The periphery of the friction piece 184 resists the elastic pieces 188, and thus pushes and deforms the elastic pieces 188. Therefore, friction is generated between the friction piece 184 and the elastic pieces 188 when the display holder 30 rotates. This results in a friction moment having a direction reverse to the rotating direction. The friction moment makes the rotation of the display holder 30 about the second rotational axis quite steady, so that the display holder 30 can be stably maintained at any desired position.

It is believed that in many if not most instances, a user desires that the display holder 30 only be rotated about the first rotational axis and not about the second rotational axis. Therefore in the normal starting position of the display holder 30 in relation to the first rotational axis, the convex sides of the elastic pieces 188 abut the depressions 1844 of the friction piece 184 as regards the second rotational axis. Thus, when the display holder 30 is manually rotated about the first rotational axis away from the starting position, for any movement of the display holder 30 about the second rotational axis to occur, friction forces as between the elastic pieces 188 and the friction piece 184 must be overcome. Thereby, when the display holder 30 is rotated up about the first rotational axis as desired, unintentional rotation of the display holder 30 about the second rotational axis is avoided.

In alternative embodiments, the hinge cup 160 may be non-rotatably connected to the display holder 30, and the rotatable plate 14 may be fixed to the base body 20 correspondingly. The rotatable plate 14 may be omitted, and the second pivot shaft 189 may be fixed to the display holder 30 directly. Alternatively, the second pivot shaft 189 may be fixed to the base body 20 directly.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A swivel hinge assembly, comprising:
a main body;
a pivot mechanism connected to the main body and configured to provide the swivel hinge assembly with rotation about a first rotational axis, the pivot mechanism comprising a first pivot shaft aligned with the first rotational axis; and
a swivel mechanism connected to the main body and configured to provide the swivel hinge assembly with rotation about a second rotational axis, the swivel mechanism comprising:
a second pivot shaft extending through the main body and being rotatable relative to the main body about the second rotational axis;
a friction piece non-rotatably mounted around the second pivot shaft; and
at least one elastic piece mounted on the main body, the at least one elastic piece elastically resisting the friction piece.

2. The swivel hinge assembly as claimed in claim 1, wherein the friction piece defines at least one depression, the at least one elastic piece is arc-shaped, when the second pivot shaft is in a normal position, a convex side of the at least one elastic piece is received in the at least one depression of the friction piece and abuts the friction piece.

3. The swivel hinge assembly as claimed in claim 1, wherein the swivel mechanism further comprises a limiting piece forming a block at a periphery, the block includes two limiting surfaces, the main body forms a limiting protrusion, the limiting piece is rotatable relative to the main body and non-rotatable relative to the second pivot shaft about the second rotational axis, the block of the limiting piece and the limiting protrusion of cooperatively restrict a rotational angle of the swivel hinge assembly about the second rotational axis.

4. The swivel hinge assembly as claimed in claim 3, wherein the swivel mechanism further comprises a flat washer disposed between the main body and the friction piece, the flat washer forms a rectangular portion at an edge for preventing the flat washer from rotating relative to the main body, the flat washer defines a center hole for the second pivot shaft rotatably extending therethrough.

5. The swivel hinge assembly as claimed in claim 4, further comprising a rotatable plate, the rotatable plate, the limiting piece and the friction piece each defines a deformed latch hole, the second pivot shaft comprises a first shaft portion, a first stopping portion, a second shaft portion, a second stopping portion, and a third shaft portion arranged in that order, the third shaft portion has a cross-section approximately the same as a shape of the latch hole of the rotatable plate, the first shaft portion has a cross-section approximately the same as a shape of the latch holes of the limiting piece and the friction piece, such that the first shaft portion of the second pivot shaft is non-rotatably extended in the latch holes of the limiting piece and the friction piece, the third shaft portion is non-rotatably extended in the latch hole of the rotatable plate.

6. The swivel hinge assembly as claimed in claim 3, wherein the main body comprises a swivel, the swivel defines a circular swivel shaft hole and at least one receiving groove, the receiving groove is defined by three sidewalls and an open side is defined adjacent to the swivel shaft hole, the limiting protrusion is formed at one sidewall adjacent to the open side for defining one of the at least one receiving groove, the at least one elastic piece is disposed in the at least one receiving groove.

7. The swivel hinge assembly as claimed in claim 6, wherein the main body further comprises a first arm and a second arm extending from opposite ends of the swivel, the second arm defines a hinge shaft hole, the hinge shaft hole has a hinge shaft hole wall and defines at least one inner slot, thereby forming a step in the hinge shaft hole, the second arm further defines two hook slots communicating from the hinge shaft hole wall to an exterior surface of the second arm, the first arm defines a wiring channel for receiving wires.

8. The swivel hinge assembly as claimed in claim 7, wherein the pivot mechanism further comprises a hinge cup, a cam, a cam follower, an elastic member, and a grasping member, the first pivot shaft is extended through the grasping member, the elastic member, the cam follower, the cam, and the hinge cup, the cam is rotatably engaged with the cam follower, the cam follower is non-rotatable relative to the hinge cup, the cam, the tab washer, the grasping member and the second pivot shaft are non-rotatable relative to the main body.

9. The swivel hinge assembly as claimed in claim 8, wherein the cam and the cam follower each defines a cam surface for engaging with each other, one of the cam and the cam follower forms a pair of peaks on the cam surface, the other one of the cam and the cam follower defines a pair of valleys for engaging with or disengaging from the peaks.

10. The swivel hinge assembly as claimed in claim 8, wherein the hinge cup defines an open end, a hinge cup cavity and a hinge cup hole at a base of the hinge cup communicating with the hinge cup cavity, the hinge cup cavity has at least one flattened section so as to non-rotatably receive the cam follower, the pivotal mechanism further comprises a tab washer disposed between the elastic member and the grasping member, the first pivot shaft comprises a cap and a deformed shaft, the cam, the grasping member and the tab washer each defines a keyed hole having a shape approximately the same as a cross-section of the deformed shaft for non-rotatably surrounding the first pivot shaft.

11. The swivel hinge assembly as claimed in claim 9, wherein the cam comprises a cam portion and a neck portion, the cam surface is defined at one end of the cam portion and the neck portion is opposite to the cam surface, the neck portion and the first pivot shaft each defines a pinhole, the pivot mechanism further comprises a pin for being inserted into the pinholes so as to prevent the first pivot shaft, the grasping member, the tab washer, the elastic member, the cam follower, the cam and the hinge cup from disengaging from each other.

12. The swivel hinge assembly as claimed in claim 10, wherein the grasping member includes a base, the base and the tab washer each forms two projections at a periphery thereof so as to engaged in the inner slots of the main body, and one end of the base forms at least two hooks having a latching surface, the hooks can be bend inwards and run through the hinge shaft hole of the second arm of the main body and protrude into the hook slots, the latching surfaces of the hooks claw an end surface for defining the hook slots, and the base of the grasping member claws the step of the main body, an opposite end of the base forms two protruding rims, the tab washer is received between the protruding rims.

13. A swivel hinge assembly comprising:
a main body comprising an arm, the arm defining a hinge shaft hole and at least one hook slot communicating with the hinge shaft hole, the hinge shaft hole having a hinge shaft hole wall, hinge shaft hole wall defining at least one inner slot and a step at an end of the at least one inner slot;
a pivot mechanism connected to the main body and providing the swivel hinge assembly with rotation about a first rotational axis, the pivot mechanism comprising:
a hinge cup;
a cam partially received in the hinge cup;
a cam follower received in the hinge cup and engaging with the cam but being rotatable relative to the cam;
an elastic member elastically resisting the cam follower;
a grasping member received in the arm, wherein the grasping member includes a base, one end of the base forms at least two hooks each having a latching surface, the hooks are elastically deformable and snappingly engaged in the at least one hook slot of the arm, the latching surfaces of the hooks claw at least one end surface of the grasping member at the at least one hook slot, and the base of the grasping member abuts the step of the arm; and
a first pivot shaft, the first pivot shaft running through the grasping member, the elastic member, the cam follower, the cam, and the hinge cup, the cam follower being non-rotatable relative to the hinge cup, and the cam, the grasping member, and the first pivot shaft being non-rotatable relative to the main body; and
a swivel mechanism connected to the main body and providing the swivel hinge assembly with rotation about a second rotational axis.

14. The swivel hinge assembly as claimed in claim 13, wherein the cam and the cam follower each defines a cam surface for engaging with each other, one of the cam and the cam follower forms a pair of peaks on the cam surface, the other one of the cam and the cam follower defines a pair of valleys for engaging or disengaging with the peaks.

15. The swivel hinge assembly as claimed in claim 13, wherein the hinge cup hinge cup defines an open end, a hinge cup cavity and a hinge cup hole at a base of the hinge cup communicating with the hinge cup cavity, the hinge cup cavity has at least one flattened section so as to non-rotatably receive the cam follower, the pivotal mechanism further comprises a tab washer disposed between the elastic member and the grasping member, the first pivot shaft comprises a cap and a deformed shaft, the cam, the grasping member and the tab washer each defines a keyed hole having a shape approximately the same as a cross-section of the deformed shaft for non-rotatably surrounding the first pivot shaft.

16. The swivel hinge assembly as claimed in claim 15, wherein the base and the tab washer each forms two projections at a periphery thereof so as to define a cross-section approximately the same as the irregular hole of the main body, the base forms two protruding rims opposite to the hooks, the tab washer is received between the protruding rims.

17. The swivel hinge assembly as claimed in claim 16, wherein the swivel mechanism comprises a second pivot shaft, a friction piece and at least one elastic piece, the second pivot shaft is rotatably extended through the main body about the second rotational axis, the friction piece is non-rotatably mounted on the second pivot shaft, the at least one elastic piece is mounted on the main body, and the at least one elastic piece elastically resists the friction piece.

18. The swivel hinge assembly as claimed in claim 17, wherein the friction piece defines at least one depression, the at least one elastic piece is arc-shaped, when the second pivot shaft is in a normal position, a side of the at least one elastic piece abuts the depression of the friction piece, the main body further comprises a swivel connected to the arm, the swivel defines at least one receiving groove for receiving the at least one elastic piece.

19. The swivel hinge assembly as claimed in claim 18, wherein the swivel mechanism further comprises a limiting piece forming a block and a flat washer, the main body forms a limiting protrusion, the block of the limiting piece and the limiting protrusion of the main body cooperatively restrict a rotation angle between the second pivot shaft and the main body, the tab washer is disposed between the main body and the friction piece.

20. An electrical device comprising:
a first body;
a second body; and
a swivel hinge assembly rotatably connecting the first body and the second body and providing biaxial rotation of the first and second bodies relative to each other, the swivel hinge assembly comprising:
a main body;
a pivot mechanism connected to the main body and configured to provide the swivel hinge assembly with rotation about a first rotational axis, the pivot mechanism comprising a hinge cup rotatable relative to the main body and fixed to one of the first body and the second body; and
a swivel mechanism configured to provide the swivel hinge assembly with rotation about a second rotational axis, the swivel mechanism comprising:
a pivot shaft running through the main body and being rotatable relative to the main body about the second rotational axis;
a friction piece non-rotatably mounted around the pivot shaft;
at least one elastic piece mounted on the main body, the at least one elastic piece elastically resisting the friction piece; and
a rotatable plate fixed to the pivot shaft, the rotatable plate comprising at least one mounting portion configured for fixing the rotatable plate to the other of the first body and the second body.
